(19) United States
(12) Patent Application Publication
(10) Pub. No.: US 2023/0348804 A1
(43) Pub. Date: Nov. 2, 2023

(54) DEVICE FOR ONLINE CO-PRODUCTION OF CARBON-CONTAINING PRECURSORS AND HIGH-QUALITY OXYGEN-CONTAINING FUELS FROM BIOMASS PYROLYSIS GAS

(71) Applicant: SOUTHEAST UNIVERSITY, Nanjing (CN)

(72) Inventors: Huiyan ZHANG, Nanjing (CN); Ziwei LI, Nanjing (CN); Rui XIAO, Nanjing (CN); Xiaowen LI, Nanjing (CN)

(21) Appl. No.: 18/013,279

(22) PCT Filed: Dec. 20, 2021
(86) PCT No.: PCT/CN2021/139448

§ 371 Date: Dec. 28, 2022

(30) Foreign Application Priority Data
Jan. 21, 2021 (CN) 202110087372.2

(51) Int. Cl. C10L 1/02; B01J 8/02; B01J 4/00; B01J 19/00; B01J 19/26

(52) U.S. Cl. CPC C10L 1/02; B01J 8/025; B01J 8/0285; B01J 8/0278; B01J 4/002; B01J 4/008; B01J 19/0013; B01J 19/26; C10L 2290/141; C10L 2290/18; C10L 2290/54; C10L 2290/56; C10L 2290/60; B01J 2219/00006; B01J 2219/00033; B01J 2219/0004; B01J 2219/00058; B01J 2219/00164

(57) ABSTRACT

A device for online co-production of carbon-containing precursors and high-quality oxygen-containing fuels from biomass pyrolysis gas includes a spray polymerization reactor, where a biomass pyrolysis gas inlet and a polymerization agent inlet are provided on the spray polymerization reactor, an outlet of the spray polymerization reactor is connected to an inlet of a catalytic reactor, and an outlet of the catalytic reactor is connected to an inlet of a condenser; a spray pipe is arranged at a top in the spray polymerization reactor, and a detachable collector for collecting the carbon-containing precursors is mounted at a bottom of the spray polymerization reactor; and a catalyst is arranged in the catalytic reactor, such that micromolecular pyrolysis gas is catalytically converted into the high-quality oxygen-containing fuels.

### TECHNICAL FIELD

The present disclosure relates to the technical field of biomass resource utilization, and in particular to a device for on-line co-production of carbon-containing precursors and high-quality oxygen-containing fuels from biomass pyrolysis gas.

### BACKGROUND ART

Biomass pyrolysis for oil production is one of the most eye-catching ways of biomass utilization at present. However, since biomass has a complex structure, it is difficult to convert macromolecular pyrolysis gas produced during pyrolysis into micromolecular components, and bio-oil obtained after condensation contains a large number of heavy components that have high viscosity, poor fluidity, and difficult utilization of conversion. At present, a biomass extraction technology has high cost, and complex procedures, and accordingly scale production has not been achieved yet. In addition, the macromolecular pyrolysis gas has a large number of functional groups, easy polymerization, and a high carbon content, and is accordingly an ideal carbon source for preparing porous carbon materials. Small molecules difficult to polymerize or micromolecular organic substances produced by polymerization prepare high-quality oxygen-containing fuels by means of shape selective catalysis.

Therefore, it is particularly important to develop a compact and efficient device for online co-production of carbon-containing precursors and high-quality oxygen-containing fuels from biomass pyrolysis gas.

### SUMMARY

The present disclosure provides a device for on-line co-production of carbon-containing precursors and high-quality oxygen-containing fuels from biomass pyrolysis gas that may be utilized step by step, which not only prepares the carbon-containing precursors that may be further carbonized, but also prepares the high-quality oxygen-containing fuels by means of catalysis, thereby achieving gradient utilization of the biomass pyrolysis gas.

The technical solution used by the present disclosure is as follows:
a device for online co-production of carbon-containing precursors and high-quality oxygen-containing fuels from biomass pyrolysis gas includes a spray polymerization reactor, where a biomass pyrolysis gas inlet and a polymerization agent inlet are provided on the spray polymerization reactor, an outlet of the spray polymerization reactor is connected to an inlet of a catalytic reactor, and an outlet of the catalytic reactor is connected to an inlet of a condenser; the spray polymerization reactor is a temperature-controllable reactor, and provides a reaction space for reaction of the biomass pyrolysis gas and a polymerization agent, a spray pipe is arranged at a top in the spray polymerization reactor, and a detachable collector for collecting the carbon-containing precursors is mounted at a bottom of the spray polymerization reactor; and a catalyst is arranged in the catalytic reactor, such that micromolecular pyrolysis gas is catalytically converted into the high-quality oxygen-containing fuels.

The polymerization agent is stored in a liquid storage tank, and is conveyed by a booster pump into the spray pipe in the spray polymerization reactor, the spray pipe has a structure including a rotating shaft having an adjustable length and height, and angle-adjustable liquid spray nozzles are mounted on the rotating shaft.

An outlet of the condenser is connected to an inlet of a tail gas treatment device, such that non-condensed pyrolysis gas is deeply purified through the tail gas treatment device.

The spray polymerization reactor is a continuous feed reactor, is connected to a temperature controller, and has a temperature ranging from 50° C. to 400° C.

The catalytic reactor has an adjustable temperature, is connected to a temperature controller, and has a temperature ranging from 300° C. to 600° C.

The biomass pyrolysis gas is fed into the biomass pyrolysis gas inlet by a pipeline, and a flow meter is arranged on the pipeline.

A condensing medium of the condenser is an ice-water mixture.

The present disclosure has the beneficial effects as follows:

The present disclosure prepares the carbon-containing precursors by means of the spray polymerization reactor and the high-quality oxygen-containing fuels by means of the catalytic reactor separately to utilize the biomass pyrolysis gas step by step, thereby achieving high-valued gradient utilization of the biomass pyrolysis gas, and further solving the problems of blockage of a catalyst channel for biomass catalytic pyrolysis and poor bio-oil quality.

The device of the present disclosure tightly arranges the spray polymerization reactor and the catalytic reactor, thereby saving a large number of space and materials.

### BRIEF DESCRIPTION OF THE DRAWINGS

FIG. 1 is a schematic structural diagram of the present disclosure.

In the FIGURE: 1, valve; 2, flow meter; 3, temperature controller; 4, liquid storage tank; 5, booster pump; 6, spray polymerization reactor; 7, collector; 8, condenser; 9, tail gas treatment device, 10, catalytic reactor, 11, rotating shaft; and 12, liquid spray nozzle.

### DETAILED DESCRIPTION OF THE EMBODIMENTS

The particular embodiments of the present disclosure are described below in combination with the accompanying drawing.

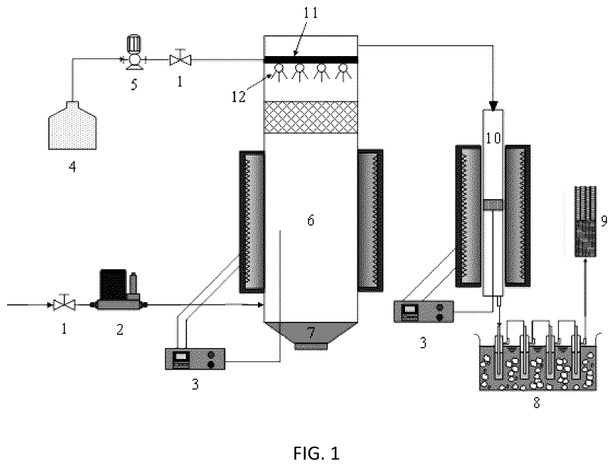

As shown in FIG. 1, a device for online co-production of carbon-containing precursors and high-quality oxygen-containing fuels from biomass pyrolysis gas of this example includes a spray polymerization reactor 6, a catalytic reactor 10, a temperature controller 3, a condenser 8, a booster pump 5, a liquid storage tank 4, a valve 1, a flow meter 2, liquid spray nozzles 12, a rotating shaft 11, a collector 7, and a tail gas treatment device 9.

The rotating shaft 11, the liquid spray nozzles 12, a valve 1, a circulation pump 2, the liquid storage tank 4, the temperature controller 3, the spray polymerization reactor 6, and the collector 7 are connected to form a carbon-containing precursor preparation device; and the catalytic reactor 10, the temperature controller 3 and the condenser 8 are connected to form a high-quality oxygen-containing fuel preparation device.

A biomass pyrolysis gas inlet and a polymerization agent inlet are provided on the spray polymerization reactor 6, an outlet of the spray polymerization reactor 6 is connected to an inlet of the catalytic reactor 10, and an outlet of the catalytic reactor 10 is connected to an inlet of the condenser 8; the spray polymerization reactor 6 is a temperature-controllable reactor, and provides a reaction space for reaction of the biomass pyrolysis gas and a polymerization agent, the rotating shaft 11 is arranged at a top in the spray polymerization reactor 6, the angle-adjustable liquid spray nozzles 12 are mounted on the rotating shaft, and the detachable collector 7 for collecting the carbon-containing precursors is mounted at a bottom of the spray polymerization reactor; and a catalyst is arranged in the catalytic reactor 10, such that micromolecular pyrolysis gas is catalytically converted into the high-quality oxygen-containing fuels.

As an embodiment, the polymerization agent is stored in the liquid storage tank 4, and is conveyed by the booster pump 5 into a spray pipe in the spray polymerization reactor 6, and the rotating shaft 11 has an adjustable length and height.

As an embodiment, an outlet of the condenser 8 is connected to an inlet of the tail gas treatment device 9, such that non-condensed pyrolysis gas is deeply purified through the tail gas treatment device 9.

As an embodiment, the spray polymerization reactor 6 is a continuous feed reactor, is connected to the temperature controller 3, and has a temperature ranging from 50° C. to 400° C.

As an embodiment, the catalytic reactor 10 has an adjustable temperature, and has a temperature ranging from 300° C. to 600° C.

As an embodiment, the biomass pyrolysis gas is fed into the biomass pyrolysis gas inlet by a pipeline, and the flow meter 2 is arranged on the pipeline.

As an embodiment, a condensing medium of the condenser 8 is an ice-water mixture.

During working, pyrolysis gas and carrier gas produced after pyrolysis of biomass pass through the valve 1 located at a front end of the flow meter 2, and the flow meter 2 to enter the spray polymerization reactor 6, a temperature is set to 250° C., the carrier gas has a flow rate of 400 mL/min, the polymerization agent enters, from the liquid storage tank 4, the rotating shaft 11 by the booster pump 5 and the valve 1 at a rear end of the booster pump 5, and is sprayed into the spray polymerization reactor 6 through the liquid spray nozzles 12, to be fully mixed with the biomass pyrolysis gas, and after macromolecular components of the biomass pyrolysis gas are fully mixed with the polymerization agent for reaction, carbon-containing precursors produced fall into the collector 7, and the collector 7 is detachable, thereby being conducive to collection of the carbon-containing precursors. Micromolecular components of the biomass pyrolysis gas and micromolecular gas produced in the reaction enter the catalytic reactor 10 below through the pipeline, and the temperature is set to 550° C. The catalyst is arranged in the catalytic reactor 10, and after the micromolecular components of the biomass pyrolysis gas are catalyzed, the oxygen-containing fuels are produced and collected in the condenser 8. Non-condensed pyrolysis gas is deeply purified by the tail gas treatment device 9, and then discharged.

What is claimed is:

1. A device for online co-production of carbon-containing precursors and high-quality oxygen-containing fuels from biomass pyrolysis gas, comprising a spray polymerization reactor (6), wherein a biomass pyrolysis gas inlet and a polymerization agent inlet are provided on the spray polymerization reactor (6), an outlet of the spray polymerization reactor (6) is connected to an inlet of a catalytic reactor (10), and an outlet of the catalytic reactor (10) is connected to an inlet of a condenser (8); the spray polymerization reactor (6) is a temperature-controllable reactor, and provides a reaction space for reaction of the biomass pyrolysis gas and a polymerization agent, a spray pipe is arranged at a top in the spray polymerization reactor (6), and a detachable collector (7) for collecting the carbon-containing precursors is mounted at a bottom of the spray polymerization reactor; and a catalyst is arranged in the catalytic reactor (10), such that micromolecular pyrolysis gas is catalytically converted into the high-quality oxygen-containing fuels.

2. The device for online co-production of carbon-containing precursors and high-quality oxygen-containing fuels from biomass pyrolysis gas according to claim 1, wherein the polymerization agent is stored in a liquid storage tank (4), and is conveyed by a booster pump (5) into the spray pipe in the spray polymerization reactor (6), the spray pipe has a structure comprising a rotating shaft (11) having an adjustable length and height, and angle-adjustable liquid spray nozzles (12) are mounted on the rotating shaft.

3. The device for online co-production of carbon-containing precursors and high-quality oxygen-containing fuels from biomass pyrolysis gas according to claim 1, wherein an outlet of the condenser (8) is connected to an inlet of a tail gas treatment device (9), such that non-condensed pyrolysis gas is deeply purified through the tail gas treatment device (9).

4. The device for online co-production of carbon-containing precursors and high-quality oxygen-containing fuels from biomass pyrolysis gas according to claim 3, wherein the spray polymerization reactor (6) is a continuous feed reactor, is connected to a temperature controller (3), and has a temperature ranging from 50° C. to 400° C.

5. The device for online co-production of carbon-containing precursors and high-quality oxygen-containing fuels from biomass pyrolysis gas according to claim 1, wherein the catalytic reactor (10) has an adjustable temperature, is connected to a temperature controller (3), and has a temperature ranging from 300° C. to 600° C.

6. The device for online co-production of carbon-containing precursors and high-quality oxygen-containing fuels from biomass pyrolysis gas according to claim 1, wherein the biomass pyrolysis gas is fed into the biomass pyrolysis gas inlet by a pipeline, and a flow meter (2) is arranged on the pipeline.

7. The device for online co-production of carbon-containing precursors and high-quality oxygen-containing fuels from biomass pyrolysis gas according to claim 1, wherein a condensing medium of the condenser (8) is an ice-water mixture.
